(19) United States
(12) Patent Application Publication
(10) Pub. No.: US 2025/0314791 A1
(43) Pub. Date: Oct. 9, 2025

(54) DEPTHWISE SPECTRAL SUBTRACTION FOR DENOISING OF SPECTRAL NOISE LOGS

(71) Applicant: Halliburton Energy Services, Inc., Houston, TX (US)

(72) Inventors: Eduardo ALVES DA SILVA, Rio de Janeiro (BR); Yadong WANG, Singapore (SG); Francisco Alirio ALMEIDA GOMES DE MOURA, Rio de Janeiro (BR); Rafael March CASTANEDA NETO, Rio de Janeiro (BR); Mahmoud SAADA, Spring, TX (US)

(73) Assignee: Halliburton Energy Services, Inc., Houston, TX (US)

(21) Appl. No.: 18/804,571

(22) Filed: Aug. 14, 2024

Related U.S. Application Data
(60) Provisional application No. 63/574,423, filed on Apr. 4, 2024.

(51) Int. Cl. G01V 1/36; G01V 1/18; G01V 1/30

(52) U.S. Cl. CPC G01V 1/36; G01V 1/186; G01V 1/307

(57) ABSTRACT

An array of hydrophones may be deployed in a wellbore to collect sounds that may be used to identify whether a wellbore is safe to operate. This hydrophone array may include acoustic sensors that sense noises indicative of a defect that could lead to catastrophic failure of a wellbore and other noises that may be considered unwanted background noises. Techniques of the present disclosure may classify noises indicative of a defect as being “signals of interest.” The presence of “background noise” may interfere with the collection and/or evaluation of “signals of interest.” Because of this, evaluations performed on data that includes “background noise” and “signals of interest” may result in inaccurate determinations being made regarding the safety of a wellbore. As such, systems and methods of the present disclosure are directed to improving safety of a wellbore by removing “background noise” more effectively while increasing quality of “signals of interest.”

### CROSS-REFERENCE TO RELATED APPLICATIONS

This application claims priority benefit to U.S. provisional patent application No. 63/574,423, filed Apr. 4, 2024 and entitled “DEPTHWISE SPECTRAL SUBTRACTION FOR DENOISING OF SPECTRAL NOISE LOGS,” the disclosure of which is incorporated by reference herein.

### TECHNICAL FIELD

The present disclosure is generally directed to improving determinations made from collected data such that a wellbore may be operated more safely or efficiently. More specifically, the present disclosure is directed to removing noise included in noise logs such that more accurate determinations may be made.

### BACKGROUND

Acoustic devices such as an array of hydrophones may be deployed in a wellbore to collect sounds used to identify whether a wellbore is safe to operate. Such an array of hydrophones may include a plurality of water-resistant acoustic sensors arranged in a line or linear pattern where each sensor may be separated from another adjacent sensor by the same distance. Collected data may include noises from different sources, where noises from certain sources are considered unwanted noises that can interfere with or mask noises indicative of an unsafe wellbore condition. The presence of unwanted noise may mask noises indicative of leaks in a wellbore structure (e.g., a wellbore casing or tube). Because of this, the presence of unwanted noise may degrade the accuracy of determinations made using data collected in a wellbore.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a hydrophone assembly that is being deployed in a wellbore, in accordance with various aspects of the subject technology.

FIG. 3 includes two different graphs that show spectral content of wellbore noises sensed at different locations of a wellbore, in accordance with various aspects of the subject technology.

FIG. 4 includes two different graphs that show spectral content of wellbore noises sensed at different locations of a wellbore, in accordance with various aspects of the subject technology.

FIG. 5 illustrates actions that may be performed to remove background noise from a set of collected data, in accordance with various aspects of the subject technology.

FIG. 6 illustrates actions that may be performed in conjunction with the actions of FIG. 5 such that background noise may be more effectively removed from a set of wellbore data, in accordance with various aspects of the subject technology.

FIG. 7 illustrates examples of results that may be obtained using techniques of the present disclosure, in accordance with various aspects of the subject technology.

FIG. 8 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

An array of hydrophones (or hydrophone assembly) may be deployed in a wellbore to collect sounds that may be used to identify whether a wellbore is safe to operate. This hydrophone array may include acoustic sensors that sense noises indicative of a defect that could lead to catastrophic failure of a wellbore and other noises that may be considered unwanted background noises. Techniques of the present disclosure may classify noises indicative of a defect as being “signals of interest.” The presence of “background noise” may interfere with the collection and/or evaluation of “signals of interest.” Because of this, evaluations performed on data that includes “background noise” and “signals of interest” may result in inaccurate determinations being made regarding the safety of a wellbore. As such, systems and methods of the present disclosure are directed to improving safety of a wellbore by removing “background noise” more effectively while increasing quality of “signals of interest.”

When a tool or assembly that includes a hydrophone array (hydrophone assembly) is deployed in a wellbore, data collected by sensors of the hydrophone assembly may sense noise from multiple sources. One significant noise source may be caused by defects (e.g., cracks or voids) in manmade subterranean structures. Such manmade structures include wellbore casings, cement that holds casings in the wellbore, and tubes that may be inside of a wellbore or a wellbore casing. A crack in a wellbore casing or tube may allow fluids either flow into or escape from the wellbore casing or tube. The movement of fluids though defects may adversely affect operation of a wellbore or potentially lead to catastrophic failure of the wellbore. As such, detecting such defects may be of paramount importance. Sounds generated based on such defects or faults in manmade structures of a wellbore may be referred to or classified as “sounds of interest” or “signals of interest.”

Other sources of noise that may be sensed by a hydrophone assembly deployed in a wellbore include noises that propagate through natural subterranean structures and into the wellbore even when there are no defects in manmade structures of a wellbore. As such, these other defects may be referred to or classified as “background noise.” This means that sensors of a hydrophone assembly may sense both “signals of interest” and “background noise.” In certain instances, background noise may obscure noises generated by wellbore defects. As such, signals of interest may be lost in a sea of background noise. When collected data includes a combination of background noise and signals of interest, evaluations made on the collected data may be error prone. As such, methods of the present disclosure are directed to reducing of the effects of “background noise” in a set of collected data such that more accurate determinations may be made regarding specific “signals of interest.” In certain instances, “signals of interest” may be synthetically generated based on work performed by engineers or based on noises generated in a laboratory environment. Such synthetic noise or actual recordings may be used to train and refine the operation of a computer model. Methods and apparatus discussed herein may be referred to as “systems and techniques” of the present disclosure. These “systems and techniques” may be used to reduce background while preserving sounds of interest.

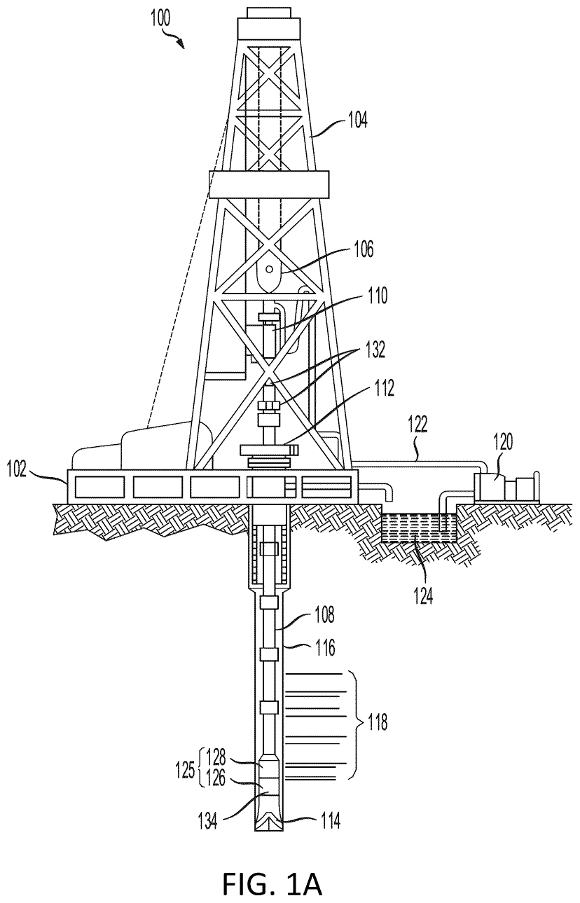

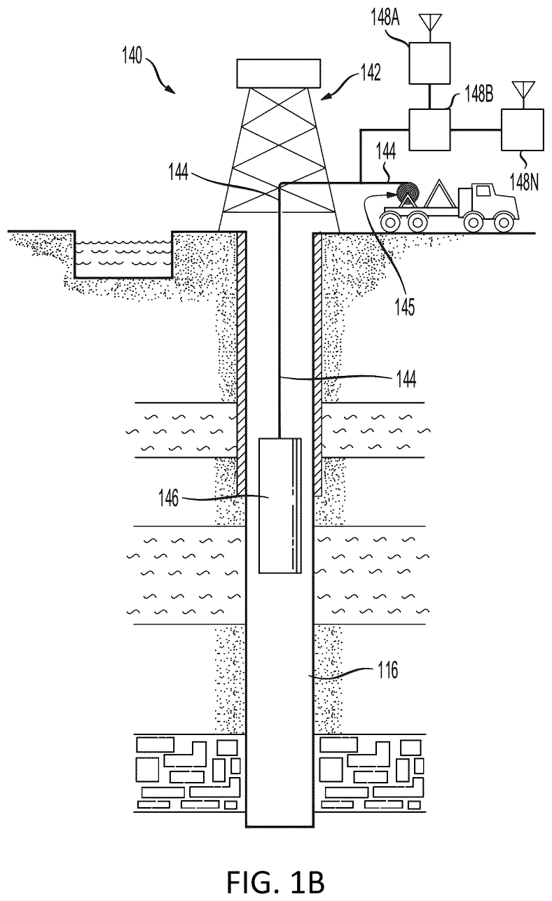

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seis mic sensors, gravity sensor, image sensors, etc.) that can acquire formation data, such as characteristics of the formation, components of the formation, etc. For example, the drilling arrangement shown in FIG. 1A can be used to gather formation data through a tool (not shown) as part of logging the wellbore using the tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. A tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

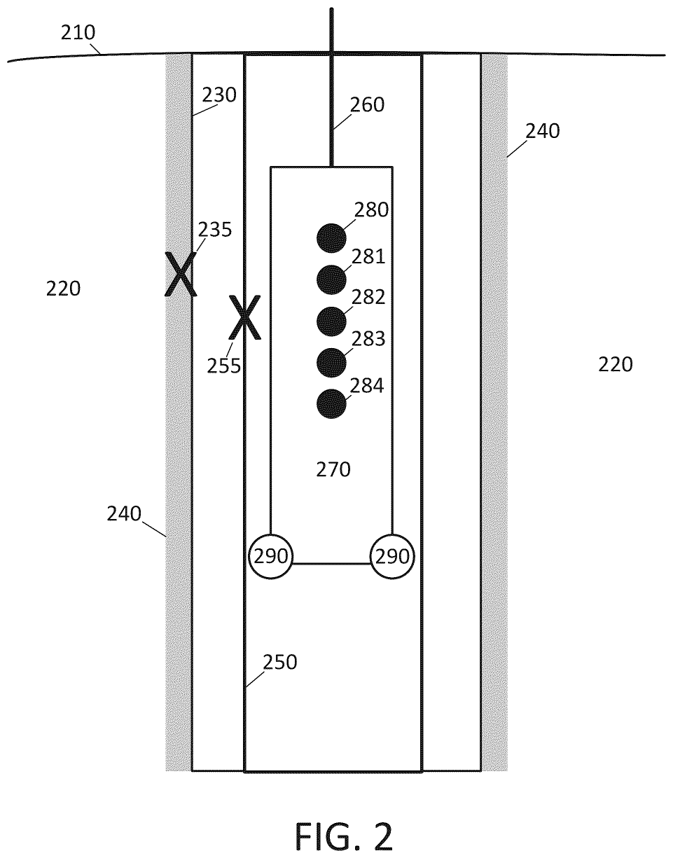

FIG. 2 illustrates a hydrophone assembly that is being deployed in a wellbore. FIG. 2 includes casing 230 cemented into a wellbore with cement 240, tube 250 that is deployed in casing 230, and hydrophone assembly 270. Hydrophone assembly 270 includes a plurality of sensors/microphones (280, 281, 282, 283, and 284), and guides 290. Deployment cable 260 may be used to lower hydrophone assembly 270 into the wellbore casing 230. FIG. 2 also includes ground surface 210 and subterranean strata 220 located below the surface of the ground 210.

While the hydrophone assembly is deployed in the wellbore, guides 290 may direct motion of the hydrophone assembly along tube 250. FIG. 2 illustrates hydrophone assembly 270 being located next to defect 235 and defect 255, where locations of each of these defects are identified by large X marks. Here defect 235 is a defect in the cement 240 and/or casing 230 of the wellbore of FIG. 2. Defect 255 is a defect in tube 250. Examples of wellbore defects are cracks or voids, and noises associated with these defects may be generated based on fluid motion. In some examples, defect 235 could allow fluid to move from subterranean strata 220 to an internal portion of casing 230 or defect 255 could allow fluids to move between an internal portion of casing 230 and an internal portion of tubing 250 or visa versa.

Sound traveling from a sound source (e.g., defect 235 or defect 255) along the tube or other structure (e.g., the casing) may travel within the wall of the tube 250 or other structure, may travel in a fluid medium adjacent to the tube or other structure, or may travel through both. When the hydrophone assembly is deployed in a wellbore, sounds sensed by sensors of the hydrophone assembly may be used to detect noises that are associated with a wellbore defect (signals of interest). When sensor 280, 281, 282, 283, and 284 sense noises made from a defect (e.g. defect 235 or defect 255), those sensors may also sense noise from other sources (e.g., noises transmitted through subterranean strata 220).

Wellbores may extend into the Earth to significant depths. For example, it is common for wellbores to extend thousands of feet into the Earth. Modern wellbores may have a circuitous path where some portions a wellbore may be vertical relative to the surface of the Earth, other portions of the wellbore may be horizontal relative to the surface of the Earth, and yet other portions of the wellbore may be canted at another angle relative to the surface of the Earth. The term depth used in the disclosure may refer to a location of the wellbore that corresponds to a distance along the wellbore from a location where the wellbore intersects the surface of the Earth. As such, each specific wellbore depth may be a specific location in a wellbore.

Certain types of sounds may be attenuated more rapidly than other types of sounds, for example sounds that include relatively lower frequencies may tend to travel through the subterranean strata of the Earth more readily than sounds that include relatively higher frequencies. In various instances, sounds generated by defects may be comprised of relatively higher frequencies as compared to noises associated with other types of wellbore phenomena. This means that areas of a wellbore that are free of leaks or “defect free areas” may include general wellbore noise (e.g., background noise) and little to no wellbore leak noise. In contrast, areas of the wellbore that include defects in manmade structures may include both leak noise and noises of other types of wellbore noise (e.g., background noise).

Systems and techniques of the present disclosure may associate wellbore depth with types of spectral content. For example, at a first wellbore depth, noises collected by a hydrophone assembly may only include background noise, and at a second wellbore depth, noises collected by the hydrophone assembly may include a combination of background noise and noises that may be classified as signals of interest.

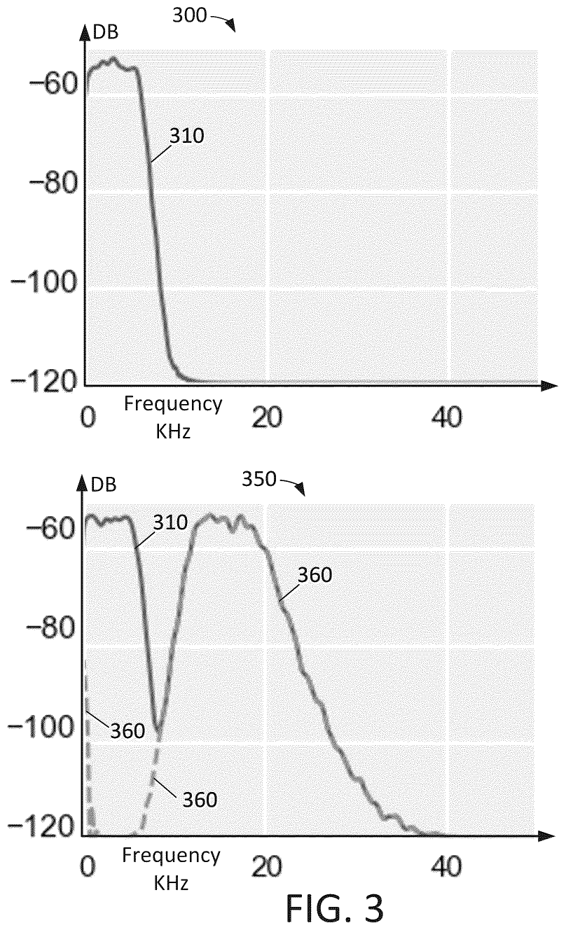

FIG. 3 includes two different graphs that show spectral content of wellbore noises sensed at different locations of a wellbore. The two different graphs of FIG. 3 are graph 300 and graph 350, each of these graphs have a vertical axis of acoustic power measured in decibels (dB) and a horizontal axis of frequency in thousands of hertz (kHz). Curve 310 of graph 300 shows spectral content associated with only wellbore background noise at a first depth of the wellbore. At this first depth, there may be no identifiable spectral content generated by leaks in manmade wellbore structures. The spectral content of curve 310 of graph 300 has a measure of power of about minus 60 dB between frequencies of about 0.1 kHz hertz to about 10 kHz. After about 10 kHz, power of the spectral content rapidly decreases to minus 120 dB.

The spectral content of graph 350 of FIG. 3 may be associated with a second depth of the wellbore. Note that noise located at this second depth includes both background noise and leak noise generated by fluids leaking through a wellbore defect. Graph 350 of FIG. 3 includes curve 310 and curve 360, where a portion of curve 310 is illustrated using a solid line and another portion of curve 360 is illustrated using a dashed line. Spectral content of leak noise is identified by curve 360. Note that the leak noise includes some spectral content between 0 and about 1 kHz and then the spectral content of curve 360 raises to about minus 65 dB at frequencies between about 12 kHz and about 2 KHz. Above 20 kHz, power associated with leak noise drops to about minus 120 DB, this occurs at frequencies of about 38 kHz. The combined spectral content of the curves of graph 350 appear almost bimodal, where most power spectral density associated with background noise is located at relatively lower frequencies (below about 10 kHz) and most of the power spectral density of the leak noise is located relative higher frequencies (above about 8 kHz to 10 kHz).

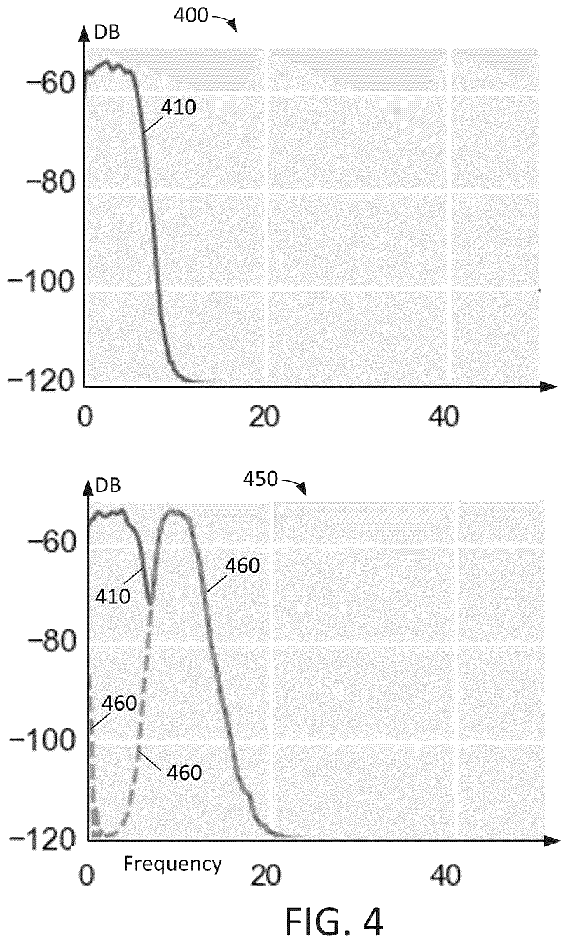

FIG. 4 includes two different graphs that show spectral content of wellbore noises sensed at different locations of a wellbore. The two different graphs of FIG. 4 are graph 400 and graph 450, each of these graphs have a vertical axis of measured power in decibels (dB) and a horizontal axis of frequency in thousands of hertz (kHz). Like curve 410 of FIG. 3, curve 410 of graph 400 includes spectral content of background noise only. Graph 450 of FIG. 4 includes curve 410 and curve 460, where the spectral content of curve 410 is associated with background noise and the spectral content of curve 460 is associated with leak noise. While the curves of FIG. 4 are not identical to the curves of FIG. 3, they are similar in that the combined spectral content of background noise and leak noise is bimodal. Here again, most of the power spectral density associated with background noise includes relatively lower frequencies and most of the power spectral density of the leak noise includes relative higher frequencies. In graph 450, most of the power spectral density of the background noise is located between about 0 KHz and about 8 kHz, and most of the power spectral density of the background noise is located between about 4 kHz and about 15 kHz.

As mentioned above, data used to draw curve 310 may be associated with a first wellbore depth and data used to draw curve 360 may be associated with a second wellbore depth. Furthermore, data used to draw curve 410 may be associated with a third wellbore depth and data used to draw curve 460 may be associated with a fourth wellbore depth. The data used to draw the curves of FIG. 3 and FIG. 4 may be associated with different depths of the same wellbore.

FIGS. 3 and 4 show that in some locations, sensors of a hydrophone assembly may only sense background noise, where at other locations, the sensors of the hydrophone assembly may sense a combination of background noise and noises that may be “signals of interest.” Since each of these different locations may be associated with a depth, portions of noise data collected by a hydrophone may be associated with a wellbore depth or range of wellbore depths. At certain depths, noises acquired by a hydrophone may be a combination of signals of interest and background noise. To evaluate and make determinations regarding signals of interest, it is desirable to reduce background noise while preserving the signal of interest as much as possible.

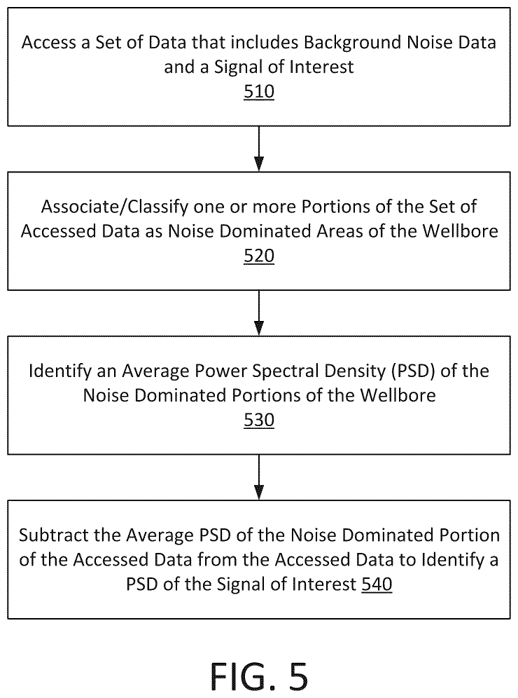

FIG. 5 illustrates actions that may be performed to remove background noise from a set of collected data. The actions performed in FIG. 5 may be performed using data collected by a hydrophone assembly deployed in a wellbore. This set of collected data may include one or more portions of information indicative of amplitudes of background noise at frequencies of the background noise and may include at least one portion of the accessed data includes a combination of signal data and background noise data.

At block 510, the set of collected data may be accessed such that respective portions of the collected data may be associated with as either noise dominated areas of the wellbore or as areas of the wellbore that include a signal of interest. This association may be made either based on a determination made automatically or based on an indication provided by a qualified operator. In one instance, collected data may be analyzed by a device (e.g., a computer) that evaluates collected noise data to identify the spectral content (e.g., frequency and amplitudes) of the collected data. For example, spectral content could be analyzed to identify noises that are consistent with or that match to a threshold degree, a signature of background noise. Areas of the wellbore that include noises that match the spectral content of the background noise and that are determined not to include spectral content consistent with other noises (e.g., leak noise) may be classified as noise dominated areas of the wellbore. Other areas of the wellbore may be classified as areas of the wellbore that include or possibly include a signal of interest. The noise dominated areas of the wellbore may be areas where a hydrophone assembly detected background noise data and no discernable signal of interest, these areas may be referred to as “noise dominated areas” of the wellbore or “noise dominated portions” of the wellbore. The areas of the wellbore that include the signal of interest may also include the background noise.

Each of these “noise dominated areas” may be associated with a wellbore depth or range of depths. Each of these depths may correspond to a distance along the wellbore from where the wellbore intersects the surface of the Earth. At block 520, the one or more portions of the wellbore may be classified as being the noise dominated areas of the wellbore. An average spectral density (PSD) of the noise dominated areas of the wellbore may be identified at block 530.

Various calculations may be performed on sets of collected data. For example, when a set of data includes data in the time domain (e.g., the space and time domain), that data may be transformed into a domain that includes the frequency domain. Data in the frequency domain may be evaluated to identify spectral content that includes an amplitude for each frequency sensed at a particular location of a wellbore. Some calculations performed may be to identify power spectral density of acquisitions at a particular depth according to formula 1.

$$\vert S ( ω , z ) {\vert}^{2} = \vert {S}_{SOI} ( ω , z ) {\vert}^{2} + {\vert N ( ω , z ) \vert}^{2} \qquad Formula 1$$

In formula 1, for a given acquisition S and depth Z for given signals S(ω, z) that may include background noise N(ω, z) and possibly a signal of interest S_{SOI}(ω, z) power associated with various frequencies or wavelengths ω may be identified. Depths where the signal of interest has a value that is close to zero or less than a threshold value, may be depths where no signal of interest is located. Such depths may be considered to only include background noise and these areas may be classified as being noise dominate areas of the wellbore. Techniques of the present disclosure may identify values of depth where there is no signal of interest, may average values of signal to obtain a noise mask value (or average noise PSD values) N̅(̅ω̅)̅. Calculations of PSD may be performed using a modified version of formula 1, shown as formula 2 below. The factor γ (Gamma) in formula 2 may be a tuning parameter that may be varied. Values of this tuning parameter may be adapted for given circumstances. The value of factor γ may be increased to emphasize the suppression background noise or may be reduced to accentuate a signal of interest. Examples of values of this tuning parameter include numeric values of 1 and 2, yet value of factor γ may be varied on a case by case basis.

$${\vert {S}_{SS} ( ω , z ) \vert}^{2} = {\vert S ( ω , z ) \vert}^{2} - γ \overline{N ( ω )} \qquad Formula 2$$

After both the average PSD of the noise dominated areas are identified, a subtraction may be performed to identify the PSD of the signal of interest at block 540. This may include subtracting the average PSD of the noise dominated areas from either a portion of the set of accessed data or from the entire set of accessed data.

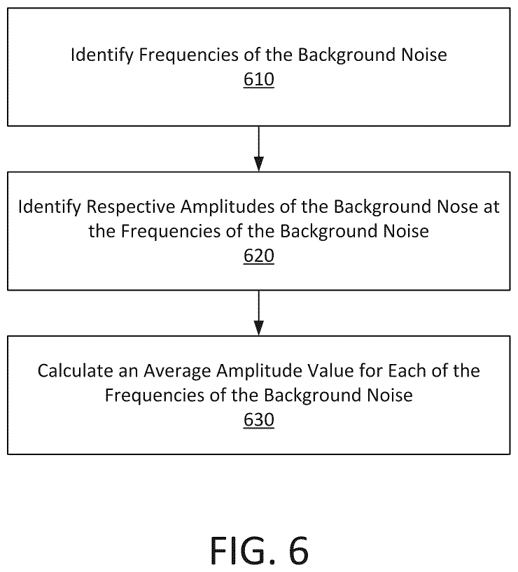

FIG. 6 illustrates actions that may be performed in conjunction with the actions of FIG. 5 such that background noise may be more effectively removed from a set of wellbore data. At block 610 frequencies of the background noise may be identified. This may include converting data in the time domain into the frequency domain using a transform like a Fourier transform. Next at block 620, minimum and maximum amplitudes of the background noise at each of the frequencies of the background noise may be identified. As such, frequencies of background noise along with amplitudes of background noise associated with different portions of a wellbore may be identified. An average amplitude for each of the frequencies of the background noise may be identified at block 630.

Other techniques may be used to identify an average amplitude for each respective frequency of background noise. For example, both maximum and minimum amplitudes for each frequency of background noise may be identified and ratios of the maximum and the minimum amplitudes may be identified. Techniques of the present disclosure may include identifying that the ratio corresponds to a ratio threshold value, and the calculated average amplitude of the background noise at the first frequency may be adjusted based on a rule associated with the ratio corresponding to the ratio threshold value. Adjustments may be made to the amplitudes at specific frequencies according to a rule associated with a principal component analysis (PCA) technique. Here, PCA may be used to identify variations in the spectral content (e.g., frequency and amplitudes) of noise collected by an array of hydrophones. A rule may identify based on spectral variations observed within a given wellbore, a percentage of total amplitudes at particular frequencies that should be suppressed.

In certain instances, a standard deviation may be calculated based on a minimum amplitude value and a maximum amplitude value of a first frequency of the frequencies of the background noise, and calculated average amplitude of the background noise may of the first frequency may be adjusted according to a rule associated with the calculated standard deviation. These standard deviation calculations may be used to identify the value of factor γ used in either formula 1 or formula 2 discussed above.

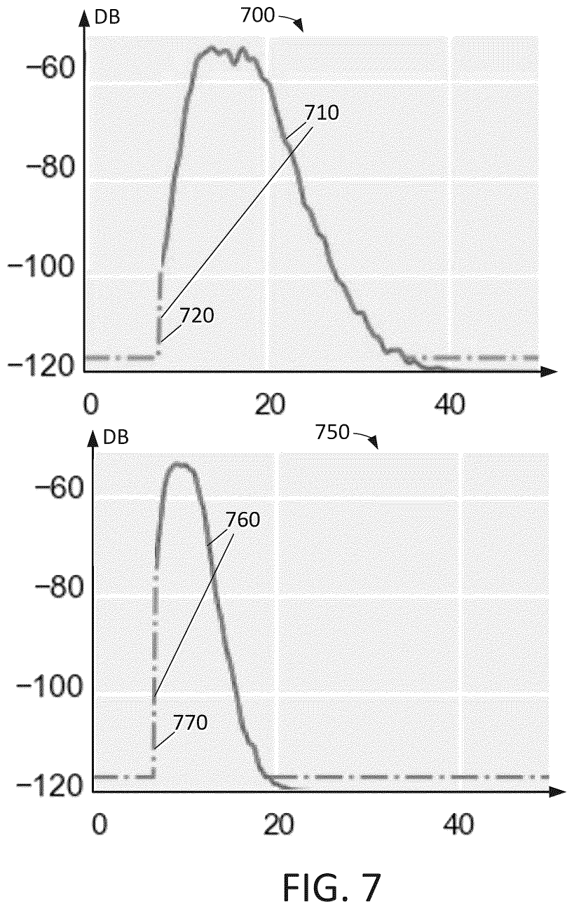

FIG. 7 illustrates examples of results that may be obtained using techniques of the present disclosure. FIG. 7 includes two different graphs 700 and 750 that each include curves indicative of content included in a truncated dataset. Curve 710 of graph 700 is representative of removing spectral content from a dataset used to draw the curves of graph 350 of FIG. 3 using techniques of the present disclosure. Formulas 1 or 2 may have been applied to a dataset that included both background noise and noise associated with a signal of interest. Similarly, curve 760 of graph 750 is representative of removing spectral content from a dataset used to draw the curves of graph 450 of FIG. 4.

Techniques of the present disclosure may be referred to as depth-wise subtraction because they use spectral content from areas of a wellbore that are dominated by background noise to subtract from spectral content included in areas of the wellbore that include both background noise and other noises (e.g., noise of a signal of interest). These techniques may result in the spectral content associated with a signal of interest being truncated at a particular frequency, this is illustrated by the dashed portion 720 of curve 710 and the dashed portion 770 of curve 760.

Once the background noise has been removed from a set of data, evaluations may be performed to identify information about the signal of interest. Such evaluations may identify the size or extent of a defect (e.g., a crack or void). Based on these evaluations, corrective actions may be identifies and performed. Such corrections may include patching a crack, filling a void, or removing a well from service.

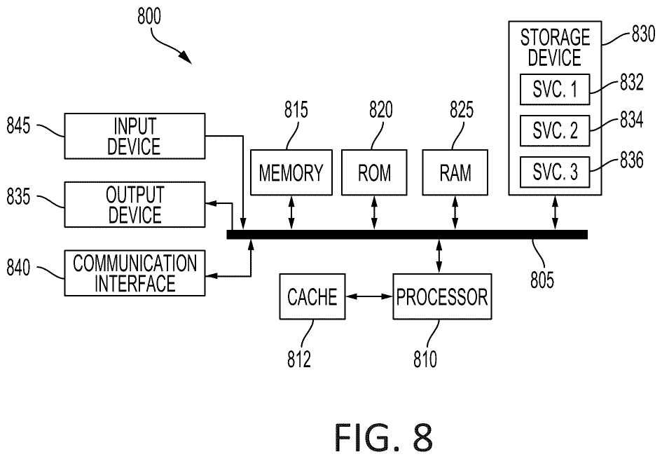

FIG. 8 illustrates an example computing device architecture which can be employed to perform any of the systems and techniques described herein. In some examples, the computing device 800 architecture can be integrated with tools described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general-purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device architecture 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative Statements of the disclosure include:
Statement 1: A method comprising: accessing data associated with a wellbore, wherein: one or more portions of the accessed data includes information indicative of amplitudes of background noise at frequencies of the background noise, and at least one portion of the accessed data includes a combination of signal data and background noise data; classifying the one or more portions of the accessed data as being noise dominated areas of the wellbore; identifying an average power spectral density (PSD) of the noise dominated portions of the accessed data, wherein the average PSD of the noise dominated portions of the accessed data include average amplitudes of the background noise at the frequencies of the background noise; and subtracting the average PSD of the noise dominated portions of the accessed data from the at least one portion of the accessed data to identify a PSD of the signal data.
Statement 2: The method of Statement 1, further comprising: identifying the frequencies of the background noise; identifying minimum and maximum amplitude values of the background noise at the frequencies of the background noise, wherein the maximum and minimum amplitude values of the background noise include a minimum amplitude value and a maximum amplitude value of a first frequency of the frequencies of the background noise; and calculating an average amplitude value of the background noise to associate with the first frequency.
Statement 3: The method of Statement 2, further comprising: calculating a ratio based on the minimum amplitude value and the maximum amplitude value of the first frequency of the frequencies of the background noise; identifying that the ratio corresponds to a ratio threshold value; and adjusting the calculated average amplitude of the background noise at the first frequency based on a rule associated with the ratio corresponding to the ratio threshold value.
Statement 4: The method of Statement 2, further comprising: calculating a standard deviation based on the minimum amplitude value and the maximum amplitude value of the first frequency of the frequencies of the background noise; and adjusting the calculated average amplitude of the background noise at the first frequency according to a rule associated with the calculated standard deviation.
Statement 5: The method of any of Statements 1 through 4, further comprising: identifying a plurality of signal amplitudes included in the combination of the signal data and the background noise data, wherein each signal amplitude of the plurality of signal amplitudes are associated with a plurality of respective frequencies according to a one-to-one correspondence.
Statement 6: The method of Statement 5, wherein the subtracting of the average PSD of the noise dominated portions of the accessed data from the at least one portion of the accessed data includes: subtracting the average amplitudes of the background noise from the amplitudes of the signal data at the plurality of respective frequencies based on the one-to-one correspondence.
Statement 7: The method of any of Statement 5, further comprising: identifying that the subtraction of the average amplitudes of the background noise from the amplitudes of the signal data results in an amplitude of signal at a first frequency of the plurality of respective frequencies being less than a noise floor level; and adjusting the amplitude of the signal at the first frequency according to a rule based on the amplitude of the signal at the first frequency of the plurality of respective frequencies being less than the noise floor level.
Statement 8: The non-transitory computer-readable storage medium having embodied thereon instructions executable by one or mor processors to implement a method comprising: accessing data associated with a wellbore, wherein: one or more portions of the accessed data includes information indicative of amplitudes of background noise at frequencies of the background noise, and at least one portion of the accessed data includes a combination of signal data and background noise data; classifying the one or more portions of the accessed data as being noise dominated areas of the wellbore; identifying an average power spectral density (PSD) of the noise dominated portions of the accessed data, wherein the average PSD of the noise dominated portions of the accessed data include average amplitudes of the background noise at the frequencies of the background noise; and subtracting the average PSD of the noise dominated portions of the accessed data from the at least one portion of the accessed data to identify a PSD of the signal data.
Statement 9: The non-transitory computer-readable storage medium of Statement 9, wherein the one or more processors execute the instructions to: identify the frequencies of the background noise; identify minimum and maximum amplitude values of the background noise at the frequencies of the background noise, wherein the maximum and minimum amplitude values of the background noise include a minimum amplitude value and a maximum amplitude value of a first frequency of the frequencies of the background noise; and calculate an average amplitude value of the background noise to associate with the first frequency.
Statement 10, The non-transitory computer-readable storage medium of Statement 9, wherein the one or more processors execute the instructions to: calculate a ratio based on the minimum amplitude value and the maximum amplitude value of the first frequency of the frequencies of the background noise; identify that the ratio corresponds to a ratio threshold value; and adjust the calculated average amplitude of the background noise at the first frequency based on a rule associated with the ratio corresponding to the ratio threshold value.
Statement 11, The non-transitory computer-readable storage medium of Statement 9, further wherein the one or more processors execute the instructions to: calculate a standard deviation based on the minimum amplitude value and the maximum amplitude value of the first frequency of the frequencies of the background noise; and adjust the calculated average amplitude of the background noise at the first frequency according to a rule associated with the calculated standard deviation.
Statement 12: The non-transitory computer-readable storage medium of any of Statements 8 through 12, wherein the one or more processors execute the instructions to: identify a plurality of signal amplitudes included in the combination of the signal data and the background noise data, wherein each signal amplitude of the plurality of signal amplitudes are associated with a plurality of respective frequencies according to a one-to-one correspondence.
Statement 13: The non-transitory computer-readable storage medium of Statement 12, wherein the subtracting of the average PSD of the noise dominated portions of the accessed data from the at least one portion of the accessed data includes: subtracting the average amplitudes of the background noise from the amplitudes of the signal data at the plurality of respective frequencies based on the one-to-one correspondence.
Statement 14: The non-transitory computer-readable storage medium of Statement 12, wherein the one or more processors execute the instructions to: identify that the subtraction of the average amplitudes of the background noise from the amplitudes of the signal data results in an amplitude of signal at a first frequency of the plurality of respective frequencies being less than a noise floor level; and adjust the amplitude of the signal at the first frequency according to a rule based on the amplitude of the signal at the first frequency of the plurality of respective frequencies being less than the noise floor level.
Statement 15: An apparatus comprising: a memory; and one or more processors that execute instructions out of the memory to: access data associated with a wellbore, wherein: one or more portions of the accessed data includes information indicative of amplitudes of background noise at frequencies of the background noise, and at least one portion of the accessed data includes a combination of signal data and background noise data; classify the one or more portions of the accessed data as being noise dominated areas of the wellbore; identify an average power spectral density (PSD) of the noise dominated portions of the accessed data, wherein the average PSD of the noise dominated portions of the accessed data include average amplitudes of the background noise at the frequencies of the background noise; and subtract the average PSD of the noise dominated portions of the accessed data from the at least one portion of the accessed data to identify a PSD of the signal data.
Statement 16: The apparatus of Statement 15, wherein the one or more processors execute the instructions to: identify the frequencies of the background noise; identify minimum and maximum amplitude values of the background noise at the frequencies of the background noise, wherein the maximum and minimum amplitude values of the background noise include a minimum amplitude value and a maximum amplitude value of a first frequency of the frequencies of the background noise; and calculate an average amplitude value of the background noise to associate with the first frequency.
Statement 17: The apparatus of Statement 16, wherein the one or more processors execute the instructions to: calculate a ratio based on the minimum amplitude value and the maximum amplitude value of the first frequency of the frequencies of the background noise; identify that the ratio corresponds to a ratio threshold value; and adjust the calculated average amplitude of the background noise at the first frequency based on a rule associated with the ratio corresponding to the ratio threshold value.
Statement 18: The apparatus of Statement 16, further wherein the one or more processors execute the instructions to: calculate a standard deviation based on the minimum amplitude value and the maximum amplitude value of the first frequency of the frequencies of the background noise; and adjust the calculated average amplitude of the background noise at the first frequency according to a rule associated with the calculated standard deviation.
Statement 19: The apparatus of Statement 16: wherein the one or more processors execute the instructions to: identify a plurality of signal amplitudes included in the combination of the signal data and the background noise data, wherein each signal amplitude of the plurality of signal amplitudes are associated with a plurality of respective frequencies according to a one-to-one correspondence.
Statement 20: The apparatus of Statement 19, wherein the subtracting of the average PSD of the noise dominated portions of the accessed data from the at least one portion of the accessed data includes: subtracting the average amplitudes of the background noise from the amplitudes of the signal data at the plurality of respective frequencies based on the one-to-one correspondence.

What is claimed is:

1. A method comprising:
accessing data associated with a wellbore, wherein:
one or more portions of the accessed data includes information indicative of amplitudes of background noise at frequencies of the background noise, and
at least one portion of the accessed data includes a combination of signal data and background noise data;
classifying the one or more portions of the accessed data as being noise dominated areas of the wellbore;
identifying an average power spectral density (PSD) of the noise dominated portions of the accessed data, wherein the average PSD of the noise dominated portions of the accessed data include average amplitudes of the background noise at the frequencies of the background noise; and
subtracting the average PSD of the noise dominated portions of the accessed data from the at least one portion of the accessed data to identify a PSD of the signal data.

2. The method of claim 1, further comprising:
identifying the frequencies of the background noise;
identifying minimum and maximum amplitude values of the background noise at the frequencies of the background noise, wherein the maximum and minimum amplitude values of the background noise include a minimum amplitude value and a maximum amplitude value of a first frequency of the frequencies of the background noise; and
calculating an average amplitude value of the background noise to associate with the first frequency.

3. The method of claim 2, further comprising:
calculating a ratio based on the minimum amplitude value and the maximum amplitude value of the first frequency of the frequencies of the background noise;
identifying that the ratio corresponds to a ratio threshold value; and
adjusting the calculated average amplitude of the background noise at the first frequency based on a rule associated with the ratio corresponding to the ratio threshold value.

4. The method of claim 2, further comprising:
calculating a standard deviation based on the minimum amplitude value and the maximum amplitude value of the first frequency of the frequencies of the background noise; and
adjusting the calculated average amplitude of the background noise at the first frequency according to a rule associated with the calculated standard deviation.

5. The method of claim 1, further comprising:
identifying a plurality of signal amplitudes included in the combination of the signal data and the background noise data, wherein each signal amplitude of the plurality of signal amplitudes are associated with a plurality of respective frequencies according to a one-to-one correspondence.

6. The method of claim 5, wherein the subtracting of the average PSD of the noise dominated portions of the accessed data from the at least one portion of the accessed data includes:
subtracting the average amplitudes of the background noise from the amplitudes of the signal data at the plurality of respective frequencies based on the one-to-one correspondence.

7. The method of claim 5, further comprising:
identifying that the subtraction of the average amplitudes of the background noise from the amplitudes of the signal data results in an amplitude of signal at a first frequency of the plurality of respective frequencies being less than a noise floor level; and
adjusting the amplitude of the signal at the first frequency according to a rule based on the amplitude of the signal at the first frequency of the plurality of respective frequencies being less than the noise floor level.

8. A non-transitory computer-readable storage medium having embodied thereon instructions executable by one or mor processors to implement a method comprising:
accessing data associated with a wellbore, wherein:
one or more portions of the accessed data includes information indicative of amplitudes of background noise at frequencies of the background noise, and
at least one portion of the accessed data includes a combination of signal data and background noise data;
classifying the one or more portions of the accessed data as being noise dominated areas of the wellbore;
identifying an average power spectral density (PSD) of the noise dominated portions of the accessed data, wherein the average PSD of the noise dominated portions of the accessed data include average amplitudes of the background noise at the frequencies of the background noise;
and
subtracting the average PSD of the noise dominated portions of the accessed data from the at least one portion of the accessed data to identify a PSD of the signal data.

9. The non-transitory computer-readable storage medium of claim 8, wherein the one or more processors execute the instructions to:
identify the frequencies of the background noise;
identify minimum and maximum amplitude values of the background noise at the frequencies of the background noise, wherein the maximum and minimum amplitude values of the background noise include a minimum amplitude value and a maximum amplitude value of a first frequency of the frequencies of the background noise; and
calculate an average amplitude value of the background noise to associate with the first frequency.

10. The non-transitory computer-readable storage medium of claim 9, wherein the one or more processors execute the instructions to:
calculate a ratio based on the minimum amplitude value and the maximum amplitude value of the first frequency of the frequencies of the background noise;
identify that the ratio corresponds to a ratio threshold value; and
adjust the calculated average amplitude of the background noise at the first frequency based on a rule associated with the ratio corresponding to the ratio threshold value.

11. The non-transitory computer-readable storage medium of claim 9, further wherein the one or more processors execute the instructions to:
calculate a standard deviation based on the minimum amplitude value and the maximum amplitude value of the first frequency of the frequencies of the background noise; and
adjust the calculated average amplitude of the background noise at the first frequency according to a rule associated with the calculated standard deviation.

12. The non-transitory computer-readable storage medium of claim 8, wherein the one or more processors execute the instructions to:
identify a plurality of signal amplitudes included in the combination of the signal data and the background noise data, wherein each signal amplitude of the plurality of signal amplitudes are associated with a plurality of respective frequencies according to a one-to-one correspondence.

13. The non-transitory computer-readable storage medium of claim 12, wherein the subtracting of the average PSD of the noise dominated portions of the accessed data from the at least one portion of the accessed data includes:
subtracting the average amplitudes of the background noise from the amplitudes of the signal data at the plurality of respective frequencies based on the one-to-one correspondence.

14. The non-transitory computer-readable storage medium of claim 12, wherein the one or more processors execute the instructions to:
identify that the subtraction of the average amplitudes of the background noise from the amplitudes of the signal data results in an amplitude of signal at a first frequency of the plurality of respective frequencies being less than a noise floor level; and
adjust the amplitude of the signal at the first frequency according to a rule based on the amplitude of the signal at the first frequency of the plurality of respective frequencies being less than the noise floor level.

15. An apparatus comprising:
a memory; and
one or more processors that execute instructions out of the memory to:
access data associated with a wellbore, wherein:
one or more portions of the accessed data includes information indicative of amplitudes of background noise at frequencies of the background noise, and
at least one portion of the accessed data includes a combination of signal data and background noise data;
classify the one or more portions of the accessed data as being noise dominated areas of the wellbore;
identify an average power spectral density (PSD) of the noise dominated portions of the accessed data, wherein the average PSD of the noise dominated portions of the accessed data include average amplitudes of the background noise at the frequencies of the background noise;
and
subtract the average PSD of the noise dominated portions of the accessed data from the at least one portion of the accessed data to identify a PSD of the signal data.

16. The apparatus of claim 15, wherein the one or more processors execute the instructions to:
identify the frequencies of the background noise;
identify minimum and maximum amplitude values of the background noise at the frequencies of the background noise, wherein the maximum and minimum amplitude values of the background noise include a minimum amplitude value and a maximum amplitude value of a first frequency of the frequencies of the background noise; and
calculate an average amplitude value of the background noise to associate with the first frequency.

17. The apparatus of claim 16, wherein the one or more processors execute the instructions to:
calculate a ratio based on the minimum amplitude value and the maximum amplitude value of the first frequency of the frequencies of the background noise;
identify that the ratio corresponds to a ratio threshold value; and
adjust the calculated average amplitude of the background noise at the first frequency based on a rule associated with the ratio corresponding to the ratio threshold value.

18. The apparatus of claim 16, further wherein the one or more processors execute the instructions to:
calculate a standard deviation based on the minimum amplitude value and the maximum amplitude value of the first frequency of the frequencies of the background noise; and
adjust the calculated average amplitude of the background noise at the first frequency according to a rule associated with the calculated standard deviation.

19. The apparatus of claim 16, wherein the one or more processors execute the instructions to:
identify a plurality of signal amplitudes included in the combination of the signal data and the background noise data, wherein each signal amplitude of the plurality of signal amplitudes are associated with a plurality of respective frequencies according to a one-to-one correspondence.

20. The apparatus of claim 19, wherein the subtracting of the average PSD of the noise dominated portions of the accessed data from the at least one portion of the accessed data includes:
subtracting the average amplitudes of the background noise from the amplitudes of the signal data at the plurality of respective frequencies based on the one-to-one correspondence.
